(19) United States
(12) Patent Application Publication
(10) Pub. No.: US 2013/0004387 A1
(43) Pub. Date: Jan. 3, 2013

(54) A Carrier Holder

(75) Inventor: Mark Barend Ter Haar, Bristol (GB)

(73) Assignee: BIOtAK, Bristol (GB)

(21) Appl. No.: 13/174,739

(22) Filed: Jun. 30, 2011

(51) Int. Cl. B01L 9/00

(52) U.S. Cl. 422/560

(57) ABSTRACT

A carrier holder that prevents contamination of a carrier before, during or after performing a test using the carrier is disclosed. The carrier holder includes an elongated member having a first end and a second end. The elongated member is substantially hollow and is configured to open radially outward at the second end. Further, the carrier holder includes one or more carriers within the elongated member. For performing a test using a carrier, one or more of a gaseous or a fluid sample is allowed to enter the elongated member through the second end. Thereafter, the carrier is dispensed directly into a receptacle when the receptacle is inserted into the second end.

### FIELD OF THE INVENTION

The present invention generally relates to a carrier holder, and more specifically, to a carrier holder that prevents contamination of a carrier by a user during or after exposure of the carrier to a test environment.

### BACKGROUND OF THE INVENTION

Typically, carriers are used to perform a variety of tests. The carriers are usually coated with one or more reagents that react with a further reagent to indicate a result of a test. For example, carriers may be used to test blood samples, urine samples, saliva samples or other bodily fluids for various anomalies. Alternatively, carriers may be used to determine presence of bacteria or other pathogens in food items or fluid samples.

These carriers are prone to contamination as a result of human interaction and also due to external contaminants. The contamination of a carrier may occur due to handling of the carrier before, during, or after a test. For example, users may use their hands when extracting a carrier from a storage container in order to perform a test, thereby inadvertently contaminating the carrier. Also, a carrier may be contaminated from external contaminants during the course of performing tests. These contaminants may be air-borne and may affect the accuracy of results provided by the carrier. Additionally, after performing a test using a carrier, the user may touch the carrier in order to present the carrier for further analysis or for future reference. This causes contamination of the carrier.

Thus, there is a need for a carrier holder that securely harbours a carrier during testing and also prevents contamination of the carrier by a user during or after exposure of the carrier to the test environment.

### BRIEF DESCRIPTION OF THE FIGURES

The accompanying figures, where like reference numerals refer to identical or functionally similar elements throughout the separate views and which together with the detailed description below are incorporated in and form part of the specification, serve to illustrate further various embodiments and to explain various principles and advantages all in accordance with the present invention.

FIG. 1A illustrates a top view of a carrier holder in accordance with an embodiment of the invention.

FIG. 1B illustrates a perspective view of a carrier holder in accordance with an embodiment of the invention.

FIG. 2 illustrates a cross-sectional view of a carrier holder in accordance with an embodiment of the invention.

FIG. 3A illustrates a side view of the carrier holder depicting a carrier contained within an elongated member in accordance with an embodiment of the invention.

FIG. 3B illustrates a side view of a carrier holder depicting an end of the elongated member opened radially outward in response to insertion of a receptacle in accordance with an embodiment of the invention.

FIG. 4 illustrates a cross-sectional view of a carrier holder with a carrier in accordance with another embodiment of the invention.

FIG. 5 illustrates a cross-sectional view of a carrier holder 500 with a carrier 502 in accordance with yet another embodiment of the invention

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a carrier holder that prevents contamination of a carrier by a user during or after exposure of the carrier to test environment. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Generally speaking, pursuant to various embodiments, the present invention provides a carrier holder that prevents contamination of a carrier by a user during or after exposure of the carrier to a sample. The carrier holder includes an elongated member having a first end and a second end. The elongated member is substantially hollow and is configured to open radially outward at the second end. Further, the carrier holder includes one or more clamping members configured to hold one or more carriers within the elongated member. The one or more clamping members are released when a receptacle is inserted into the second end to dispense the one or more carriers into the receptacle.

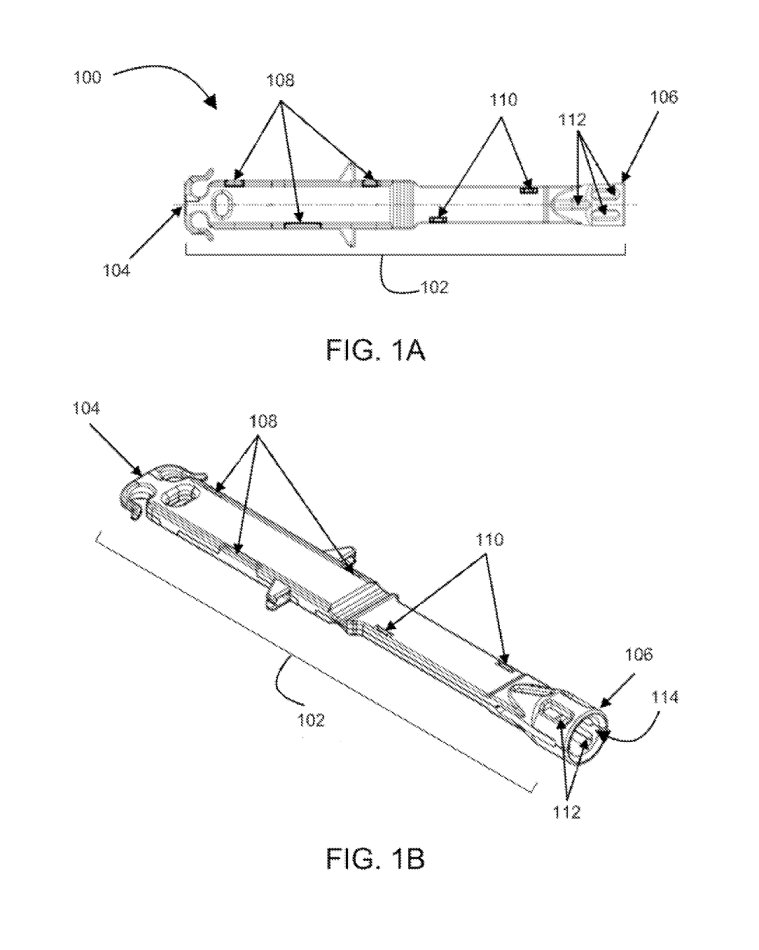

FIG. 1A and FIG. 1B illustrate a top view and a perspective view respectively of a carrier holder 100 in accordance with an embodiment of the invention. Carrier holder 100 includes an elongated substantially hollow member 102 (hereinafter referred as elongated member 102) having a first end 104 and a second end 106. Elongated member 102 includes two or more elongated segments. For example, elongated member 102 may include two identical length-wise segments. These length-wise segments may include an upper segment and a lower segment divided along the length of carrier holder 100. It will be apparent to a person skilled in the art that the number of elongated segments need not be limited to two but can include any number of elongated segments.

The two or more elongated segments are coupled to each other using a plurality of fasteners. In an embodiment, the fasteners are interference fit fasteners. Interference fit fasteners include press fit fasteners and friction fit fasteners. These fasteners couple the two or more elongated segments together and enable one or more carriers to be securely harbored within elongated member 102. In an embodiment, the plurality of fasteners may include a first set of fasteners 108 proximal to first end 104 and a second set of fasteners 110 proximal to second end 106.

In an embodiment, first set of fasteners 108 proximal to first end 104 are configured to fixedly couple the two or more elongated segments of elongated member 102. For example, first set of fasteners 108 may include snap-fit fasteners. Here, the two or more elongated segments are coupled at the first end 104 in a manner so as to lock the two or more elongated segments together.

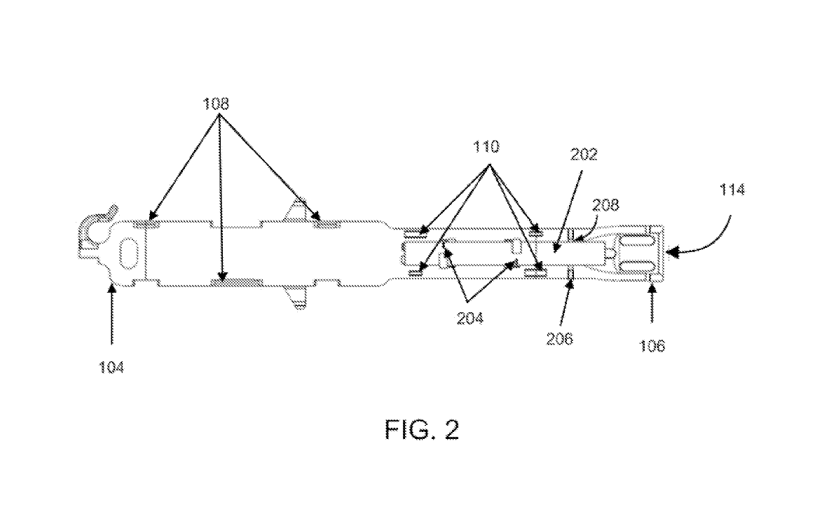

Proximal to second end 106, second set of fasteners 110 are configured to releasably couple the two or more elongated segments of elongated member 102. Second set of fasteners 110 may include friction fit fasteners which may be released with minimal force. To enable performing a test using carrier holder 100, second end 106 may also include one or more openings such as openings 112 to allow one or more of a gaseous or a fluid sample to enter elongated member 102. Performing a test using carrier holder 100 is further explained in conjunction with FIG. 2.

Second set of fasteners 110 enable second end 106 of carrier holder 100 to open radially outward in response to inserting a receptacle into second end 106. Second end 106 includes a cavity 114 for receiving the receptacle. When a receptacle is inserted at second end 106 through cavity 114, second set of fasteners 110 get released. Therefore, on inserting the receptacle into second end 106 through cavity 114, the one or more carriers contained within elongated member 102 are dispensed into the receptacle. Dispensing the one or more carriers is further explained in conjunction with FIG. 2.

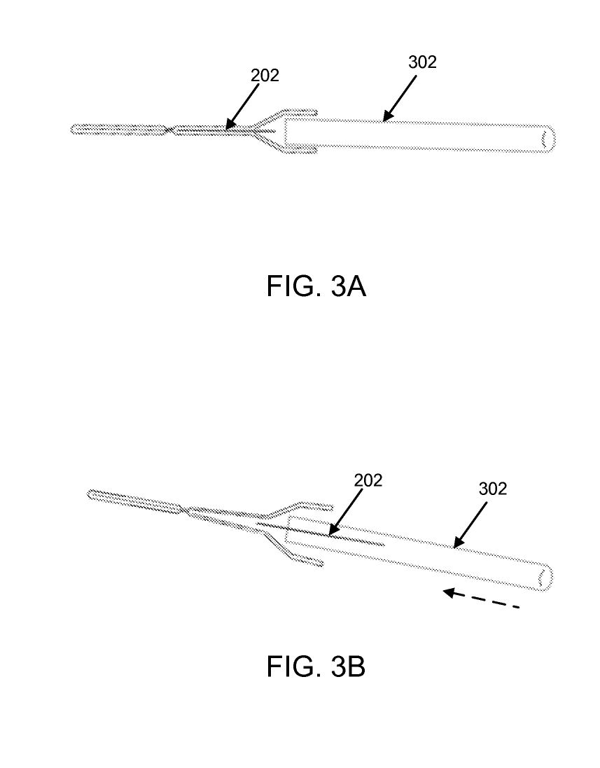

FIG. 2 illustrates a cross-sectional view of carrier holder 100 in accordance with an embodiment of the invention. As illustrated in FIG. 2, one or more carriers such as carriers 202 are contained within elongated member 102. Also, a side view of carrier holder 100 depicting carriers 202 contained within elongated member 102 is shown in FIG. 3A. In an embodiment, carriers 202 may be placed within elongated member 102 during manufacture of carrier holder 100. This prevents handling of carriers 202 by a user prior to performing a test using carriers 202. Within elongated member 102, carriers 202 may be held in place by one or more clamping members such as clamping members 204. Clamping members 204 may be coupled to an inner wall proximal to second end 106. In an embodiment, clamping members 204 may include two piece clamps that are engaged when the two or more elongated members are coupled together.

Carrier holder 100 further includes a separating member 206 proximal to second end 106 of elongated member 102. Separating member 206 includes an aperture 208 through which carriers 202 partially protrudes into cavity 114 as illustrated in FIG. 2. Here, aperture 208 may be configured to allow one or more of a gaseous or a fluid sample to flow into elongated member 102 and contact carrier 202. Additionally, the extent of protrusion of carrier 202 into cavity 114 is such as to allow efficient contact of the gaseous or fluid sample with carrier 202 but prevent access to carrier 202 by a user through cavity 114. Also, the opening of cavity 114 may be sized such that touching of carrier 202 by a user is prevented. Thus, this restricts access of a user to carrier 202 thereby shielding carrier 202 from contamination caused by touching of carrier 202 by a user.

To perform a test, carrier holder 100 may be brought into the presence of a gaseous or fluid sample to be tested. The sample flows into cavity 114 through one or more of the openings to cavity 114 and openings 112 and comes in contact with the partially protruded portion of the carrier 202. Additionally, the sample may flow through aperture 208 in separating member 206 to contact carrier 202. On contacting carrier 202, the sample reacts with one or more reagents or one or more enzymes coated on carrier 202 to allow a test result to be produced.

Once a test has been carried out using carrier 202, carrier 202 is dispensed from carrier holder 100. To dispense carrier 202, a receptacle 302 is inserted at second end 106 as illustrated in FIG. 3B. The insertion of receptacle 302 is facilitated through cavity 114. In an embodiment, the opening to cavity 114 may be circular in shape to allow a cylindrically shaped receptacle to be inserted at second end 106. It will be apparent to a person skilled in the art that the opening to cavity 114 is not limited to a circular shape but may include other shapes as well.

The insertion of receptacle 302 causes second set of fasteners 110 proximal to second end 106 to release the one or more elongated segments at second end 106 of elongated member 102. In other words, the insertion of receptacle 302 pries open second end 106 causing second end 106 to open radially outward as illustrated in FIG. 3B. In an exemplary embodiment, if elongated member 102 includes two elongated segments such as an upper segment and a lower segment, then the upper segment and lower segment are partially caused to move apart from each other at second end 106 when receptacle 302 is inserted at second end 106. As a result of second end 106 being pried open, clamping members 204 coupled to the inner wall proximal to second end 106 also move apart from each other thereby releasing carrier 202. Carrier 202 may then be directly dispensed into receptacle 302. Dispensing of carrier 202 into receptacle 302 may be gravity assisted. Alternatively, dispensing of carrier 202 may be through a spring loaded mechanism. Here, the spring loaded mechanism may be released when second end 106 is pried open to dispense carrier 202 into receptacle 302.

In an exemplary embodiment, carrier holder 100 may be used to assess the presence of one or more of a compound, a biological agent or an analyte in an environmental sample. The environmental sample may include a water sample, a sewage sample, and a soil sample. In order to assess the environmental sample, carrier holder 100 containing carrier 202 within it may be immersed into the environmental sample. This allows the environmental sample to flow into elongated member 102 and contact carrier 202. Thereafter, carrier holder 100 may be removed and rinsed in clean water. Subsequently, carrier 202 is dispensed directly into a receptacle as explained in conjunction with FIG. 2. Carrier holder 100 may then be disposed. Here, the receptacle may be a tube used for preserving carrier 202 for further analysis or for transporting carrier 202. Thus, carrier 202 is prevented from contamination either during or after a test.

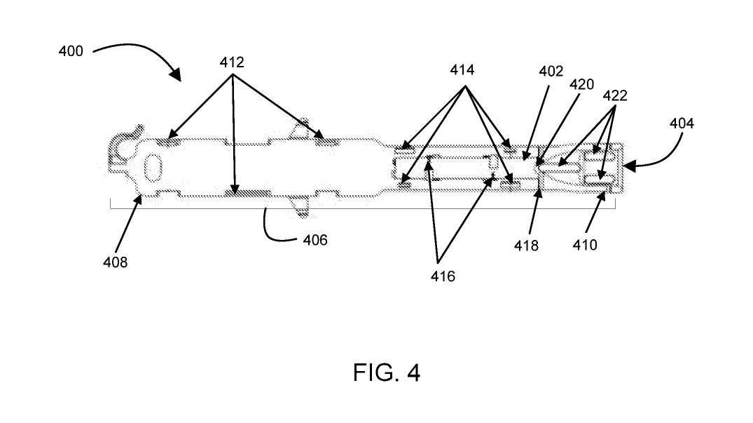

FIG. 4 illustrates a cross-sectional view of a carrier holder 400 with a carrier 402 in accordance with another embodiment of the invention. Here, carrier 402 does not protrude into a cavity 404. Carrier holder 400 includes an elongated substantially hollow member 406 (herein after referred as elongated member 406) having a first end 408 and a second end 410. Elongated member 406, first end 408, and second end 410 are functionally and structurally similar to elongated member 102, first end 104, and second end 106 respectively of carrier holder 100. Carrier holder 400 further includes a first set of fasteners 412 and a second set of fasteners 414 functionally and structurally similar to first set of fasteners 108 and second set of fasteners 110 respectively of carrier holder 100.

Further, carrier holder 400 includes one or more clamping members such as clamping members 416 similar to clamping members 204 of carrier holder 100. Clamping members 416 are configured to hold carrier 402 within elongated member 406. On inserting a receptacle at second end 410 through cavity 404, clamping members 416 are configured to release carrier 402 thereby directly dispensing carrier 402 into the receptacle.

Additionally, carrier holder 400 includes a separating member 418 proximal to second end 410 of elongated member 406. Separating member 418 includes one or more apertures such as an aperture 420. The one or more apertures in separating member 418 are configured to allow one or more of a gaseous or a fluid sample to flow into elongated member 406 and contact carrier 402. Moreover, the one or more apertures in separating member 416 may be sized to allow the one or more of the gaseous and the fluid sample to flow into elongated member 406 but prevent a user from touching carrier 402 through the one or more apertures. Additionally, carrier holder 400 may include one or more openings such as openings 422 to allow the one or more of a gaseous and a fluid sample to contact carrier 402.

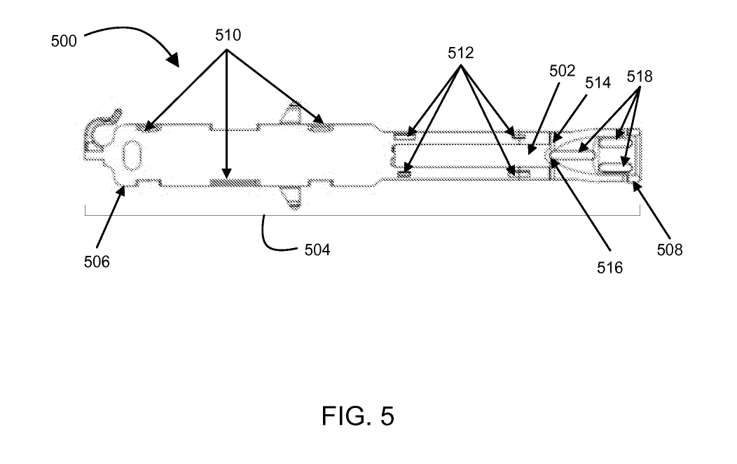

FIG. 5 illustrates a cross-sectional view of a carrier holder 500 with a carrier 502 in accordance with yet another embodiment of the invention. Carrier holder 500 includes an elongated member 504 having a first end 506 and a second end 508. Elongated member 504, first end 506, and second end 508 are functionally and structurally similar to elongated member 102, first end 104, and second end 106 respectively of carrier holder 100. Elongated member 504 includes two or more elongated segments as explained in conjunction with FIG. 1. The two or more elongated segments of elongated member 504 are coupled to each other using a plurality of fasteners. In an embodiment, the fasteners are interference fit fasteners. Interference fit fasteners include press fit fasteners and friction fit fasteners. These fasteners couple the two or more elongated segments together and enable carrier 502 to be securely harbored within elongated member 504. In an embodiment, the plurality of fasteners may include a first set of fasteners 510 proximal to first end 506 and a second set of fasteners 512 proximal to second end 508. First set of fasteners 510 and a second set of fasteners 512 are functionally and structurally similar to first set of fasteners 108 and second set of fasteners 110 respectively of carrier holder 100.

Here, carrier holder 500 may be manufactured with carrier 502 retained inside elongated member 504. In this case, carrier 502 may be held within elongated member 504 as a result of friction caused by the two or more elongated segments of elongated member 504. Alternatively, elongated member 504 may include a depression such that carrier 502 fits into the depression when the two or more elongated members are held together by the plurality of fasteners. It will be evident to a person skilled in the art that other known designs or mechanisms may be used to securely retain carrier 502 within elongated member 504 without deviating from the scope of the invention.

Carrier holder 500 further includes a separating member 514 proximal to second end 508 of elongated member 504. Separating member 514 includes one or more apertures such as an aperture 516. The one or more apertures in separating member 514 are configured to allow one or more of a gaseous or a fluid sample to flow into elongated member 504 and contact carrier 502. Moreover, the one or more apertures in separating member 514 may be sized to allow the one or more of the gaseous and the fluid sample to flow into elongated member 504 but prevent a user from touching carrier 502 through the one or more apertures. Further, the one or more apertures may be sized to prevent carrier 502 from sliding out of elongated member 504 when the two or more segments of the elongated member are held together by the plurality of fasteners. Additionally, carrier holder 500 may include one or more openings such as openings 518 to allow the one or more of a gaseous and a fluid sample to contact carrier 502.

Various embodiments of this disclosure provide a carrier holder that prevents contamination of a carrier before, during, or after performing a test using the carrier. The carrier holder disclosed herein is configured to securely harbour the carrier within a substantially hollow elongated member and protect the carrier from external stressors and from external contamination. Additionally, the carrier holder is configured not to dispense the carrier unless a clamping mechanism is released. The clamping mechanism is released only when a receptacle is inserted into an end of the elongated member. As a result, the carrier is directly dispensed into the receptacle thereby preventing contamination of the carrier. In an embodiment, the carrier may be placed within the elongated member at the time of manufacture of the carrier holder and dispensed into a receptacle after use. Thus, this prevents the contamination of the carrier before, during, or after use.

Those skilled in the art will realise that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A carrier holder comprising:
an elongated member comprising a first end and a second end, the second end configured to open radially outward, wherein at least a portion of the elongated member is substantially hollow;
at least one clamping member configured to hold at least one carrier within the elongated member, wherein the at least one clamping member is coupled to an inner wall proximal to the second end;
wherein the second end is configured to open radially outward in response to inserting a receptacle into the second end thereby releasing the at least one clamping member to dispense the at least one carrier into a receptacle.

2. The carrier holder of claim 1, wherein the second end comprises a cavity for receiving the receptacle.

3. The carrier holder of claim 1, wherein the elongated member comprises at least two elongated segments.

4. The carrier holder of claim 3 further comprising a plurality of fasteners for coupling the at least two elongated segments to each other.

5. The carrier holder of claim 4, wherein the plurality of fasteners comprises interference fit fasteners.

6. The carrier holder of claim 4, wherein the plurality of fasteners comprises a first set of fasteners proximal to the first end of the elongated member and a second set of fasteners proximal to the second end of the elongated member.

7. The carrier holder of claim 6, wherein the first set of fasteners fixedly couples the at least two elongated segments.

8. The carrier holder of claim 6, wherein the second set of fasteners releasably couples the at least two elongated segments.

9. The carrier holder of claim 1, wherein the elongated member comprises at least one separating member proximal to the second end for restricting access of a user to the at least one carrier prior to dispensing at least one carrier into the receptacle.

10. The carrier holder of claim 9, wherein the at least one separating member comprises at least one aperture to allow at least one of a gas or a fluid to flow into the elongated member to contact the at least one carrier.

11. A carrier holder comprising:
an elongated member comprising a first end and a second end, the second end configured to open radially outward; and
the second end configured to retain a carrier therein, to allow access of a gaseous or liquid material to the carrier, and to open radially outward in response to inserting a receptacle into the second end.

12. The carrier holder of claim 11, wherein the second end comprises a cavity for receiving the receptacle.

13. The carrier holder of claim 11, wherein the elongated member comprises at least two elongated segments.

14. The carrier holder of claim 13 further comprising a plurality of fasteners for coupling the at least two elongated segments to each other.

15. The carrier holder of claim 14, wherein the plurality of fasteners comprises interference fit fasteners.

16. The carrier holder of claim 14, wherein the plurality of fasteners comprises a first set of fasteners proximal to the first end of the elongated member and a second set of fasteners proximal to the second end of the elongated member.

17. The carrier holder of claim 16, wherein the first set of fasteners fixedly couples the at least two elongated segments.

18. The carrier holder of claim 16, wherein the second set of fasteners releasably couples the at least two elongated segments.

19. The carrier holder of claim 11, wherein the elongated member comprises at least one separating member proximal to the second end for restricting access of a user to the at least one carrier prior to dispensing at least one carrier into the receptacle.

20. The carrier holder of claim 19, wherein the at least one separating member comprises at least one aperture to allow at least one of a gas or a fluid to flow into the elongated member to contact the at least one carrier.
